(19) United States
(12) Patent Application Publication
(10) Pub. No.: US 2012/0007967 A1
(43) Pub. Date: Jan. 12, 2012

(54) VIDEO SYSTEM, EYEGLASS DEVICE AND VIDEO PLAYER

(76) Inventors: Mitsufusa KONDO, Osaka (JP); Kazuhito Kimura, Shiga (JP)

(21) Appl. No.: 13/242,596

(22) Filed: Sep. 23, 2011

Related U.S. Application Data
(63) Continuation of application No. PCT/JP2011/001299, filed on Mar. 4, 2011.

(30) Foreign Application Priority Data
Mar. 5, 2010 (JP) 2010-049835

(51) Int. Cl. H04N 13/04

(52) U.S. Cl. 348/54; 348/E13.036

(57) ABSTRACT

A video system includes a video player for playing data of contents and an eyeglass device used to view a video. The eyeglass device includes an optical filter portion for adjusting a light amount reaching eyes of a viewer, a battery used as a power supply of the eyeglass device, and a first transceiver for transmitting remaining charge information on battery charge remaining in the battery and receiving a synchronization signal for controlling the optical filter portion. The video player includes a second transceiver for receiving the remaining battery charge information and transmitting the synchronization signal, and a controller for calculating a time period represented by operational time information of the eyeglass device based on the remaining battery charge information and causing the second transceiver to transmit the synchronization signal so as to make the optical filter portion less frequently operated.

### TECHNICAL FIELD

The present invention is related to a video system, an eyeglass device and a video player, which provide a video to be stereoscopically perceived by a viewer.

### BACKGROUND ART

It is not preferable that a battery is run out during use of a device configured to play and display a video, like a general electric device. Therefore, various technologies to reduce power consumption of a device have been proposed (e.g., see Patent Document 1).

A video system configured to provide a video to be stereoscopically perceived by a viewer typically includes a video player which plays and displays the video, and an eyeglass device which assists in stereoscopically viewing the video, which is displayed by the video player. For example, the video player alternately displays a left frame image to be viewed by the left eye and a right frame image to be viewed by the right eye. While the left frame image is displayed, the eyeglass device makes the left frame image viewed through a left filter situated in front of the left eye of the viewer whereas the eyeglass device does not allow the left frame image to be viewed by the right eye of the viewer through a right filter situated in front of the right eye. Likewise, while the right frame image is displayed, the eyeglass device allows the right frame image to be viewed through the right filter whereas the eyeglass device does not allows the left frame image to be viewed by the left eye through the left filter. Thus, the viewer may stereoscopically perceive the video provided by the video player.

Electric power is required for the aforementioned operations of the video player and the eyeglass device. In particular, a portable battery such as a primary or secondary battery to supply power is typically mounted to the eyeglass device because the eyeglass device is worn by the viewer.

Known power-saving technologies as disclosed in Patent Document 1 do not fundamentally solve and prevent problems that the eyeglass device runs out of the battery while data of contents are played although the known technologies may lengthen an operational time period of the eyeglass device. For example, if the data of contents which the video player plays has a longer playing period in total than an operational time period, which is allowed by remaining battery charge of the eyeglass device, it becomes likely that the eyeglass device runs out of the battery while the data of contents are played. Thus, the operational time period required for the eyeglass device, which is used in a video system, depends on a total length of the playing period of the data of contents, which is played by the video player that is provided separately from the eyeglass device. There have been no technologies so far to prevent troubles such as the battery exhaustion of the eyeglass device on the basis of the total length of the playing period of the data of contents.

If the eyeglass device runs out of the battery, it becomes less likely that the eyeglass device performs the aforementioned stereoscopic vision assistance in synchronization with the frame image of the video provided by the video player. As a result, the viewer wearing the eyeglass device, which runs out of battery, may suddenly fail to view the video while the viewer views the video (e.g., if the left and right filters continue a closed orientation). Alternatively, the viewer may view the left frame image with the right eye whereas the viewer may view the right frame image with the left eye (e.g., if the left and/or right filters are operated asynchronously with the frame image of the video or if the left and/or right filter continues an opened orientation). Such troubles may make the viewer greatly uncomfortable.

Patent Document 1: Japanese Patent Application Laid-open No. H11-66828

### SUMMARY OF THE INVENTION

In view of the aforementioned circumstances, an object of the present invention is to provide a video system, an eyeglass device and a video player, which suppress battery consumption of an eyeglass device in response to a playing period of data of contents.

A video system according to an aspect of the present invention includes: a video player configured to play data of contents to make a video stereoscopically perceived; an eyeglass device used to view the video, wherein the eyeglass device includes: an optical filter portion configured to adjust a light amount reaching eyes of a viewer so that the viewer stereoscopically perceives the video; a battery used as a power supply of the eyeglass device; and a first transceiver configured to transmit information associated with battery charge remaining in the battery to the video player and to receive a synchronization signal for controlling the optical filter portion, and the video player includes: a second transceiver configured to receive the information about the remaining battery charge and to transmit the synchronization signal; and a controller configured to selectively switch an operation mode of the video player based on a comparison result between a playing period of the data of contents and operational time information representing a remaining time period during which the eyeglass device are operable, the operational time information obtained from the received information about the remaining battery.

An eyeglass device used to view a video according to another aspect of the present invention includes: an optical filter portion configured to adjust a light amount reaching eyes of a viewer so that the viewer stereoscopically perceives the video; a battery used as a power supply of the eyeglass device; and a first transceiver configured to transmit remaining charge information about battery charge remaining in the battery to a video player and to receive a synchronization signal for controlling the optical filter portion.

A video player for playing data of contents to make a video stereoscopically perceived by means of an eyeglass device according to yet another aspect of the present invention includes: a second transceiver configured to receive information about charge remaining in a battery used as a power supply of the eyeglass device and to transmit a synchronization signal for controlling the eyeglass device; and a controller configured to calculate a remaining time period, during which the eyeglass device are operable, represented by operational time information obtained from the received information about the charge remaining in the battery, the controller makes the second transceiver transmit the synchronization signal to decrease consumption of the battery if a playing period of the data of contents is longer than the remaining time period represented by the operational time information.

### BRIEF DESCRIPTION OF THE DRAWINGS

FIG. 1 is a schematic view of a video system according to one embodiment.

FIG. 2 is a block diagram of a video player of the video system shown in FIG. 1.

FIG. 3 is a block diagram of an eyeglass device of the video system shown in FIG. 1.

FIG. 4 is a schematic flow chart showing an operation to transmit remaining charge information from the eyeglass device shown in FIG. 3.

FIG. 5 is a schematic flow chart showing another operation to transmit the remaining charge information from the eyeglass device shown in FIG. 3.

FIG. 6 is a schematic flow chart showing yet another operation to transmit the remaining charge information from the eyeglass device shown in FIG. 3.

FIG. 7 is a schematic flow chart showing an operation to play data of contents by the video player shown in FIG. 2 after the video player acquires the remaining charge information.

FIG. 8 is a schematic timing chart showing a video signal generated by a video processor, a synchronization signal generated by a transmission controller and operations of left and right filters in response to the synchronization signal.

FIG. 9 is a schematic timing chart showing the video signal generated by the video processor, the synchronization signal generated by the transmission controller and the operations of the left and right filters in response to the synchronization signal.

FIG. 10 is a schematic flow chart showing operation of a controller of the video player shown in FIG. 2.

FIG. 11 is a schematic view showing a method for allocating a 3D playing period and a 2D playing period to the playing period of the data of contents.

FIG. 12 is a schematic view showing a method for allocating the 3D playing period to digested portions of the data of contents.

FIG. 13 is a schematic view showing a method for setting a 3D playing period from the leading portion of the data of contents according to operational time information.

FIG. 14 is a schematic flow chart showing an operation of the video player shown in FIG. 2, which receives a special playing signal.

FIG. 15 is a schematic view showing a time acquisition operation in Step S1307 shown in FIG. 14.

FIG. 16 is a schematic view showing a time acquisition operation during rewinding play mode of a video.

FIG. 17 is a flow chart showing operation to set the operational time information on the basis of the remaining charge information acquired after an end signal is received.

FIG. 18 is a schematic timing chart showing less frequent communication of the synchronization signal.

### DESCRIPTION OF THE INVENTION

A video system according to the present embodiments is described hereinafter with reference to the accompanying drawings.

### DEFINITIONS OF TERMS

The term “data of contents” used in the following descriptions means data representing contents of programs viewed by means of a display device such as a television device (including a device with a STB (Set Top Box)) configured to receive a broadcast signal (e.g., general television broadcast, cable television broadcast or satellite broadcast), data representing information such as titles, chapters or playlists contained in a DVD disk, a Blu-ray disc or another storage medium (e.g., SD, USB memory, SSD or HDD), data available or viewed through the Internet (e.g., data stored in moving image files such as download is files, mp4 files or data played and viewed in a streaming method) or another data which may be displayed as a video on the display device. The data of contents may be coded according to any method such as the MPEG (Motion Picture Experts Group)-2, the MPEG-4, the H264 or alike.

The video system according to the present embodiments acquires information about a playing period of the aforementioned data of contents to reduce battery consumption of an eyeglass device of the video system. If the data of contents are a broadcast signal, for example, the information about the playing period may be acquired from the EIT (Event Information Table) of the MPEG2 system. If the data of contents are contained in a storage medium such as a DVD disk or Blu-ray disk, information about the playing period of titles and chapters may be acquired from management information generally stored together with the data of contents in the storage medium. If the data of contents are file data available or viewed through the Internet, the information about the playing period may be acquired from metadata showing the playing period of a file or management information (e.g., a moov container box (container) in the MP4 file format (ISO/IEC 14496)) accompanying the file.

The term “operational time information of a stereoscopic vision assistance allowed by remaining battery charge” or a similar term in the present embodiments means a time period during which a viewer may stereoscopically perceive a video by means of the eyeglass device. Therefore, a time period during which the eyeglass device does not follow frame image display of the video (i.e., an asynchronous period or an operation stop period) is excluded from the operational time information of the stereoscopic vision assistance. The term “operational time information of a stereoscopic vision assistance allowed by remaining battery charge” also means not only a maximum time period during which the eyeglass device physically or electrically follows the frame image display of the video to make the viewer stereoscopically perceive the video, but also a logically calculated maximum time period, a time period set on the basis of the calculated maximum time period with taking account of an estimated safety factor, and a time period appropriately determined according to another method.

The phrases “the left/right filter is opened” or similar phrases mean that a light amount reaching the left/right eye of the viewer through the left/right filter increases.

The phrases “the left/right filter is closed” or similar phrases mean that the light amount reaching the left/right eye of the viewer through the left/right filter decreases.

In the present embodiment, when the left/right filter is closed, the left/right filter blocks light. Alternatively, the left/right filter may deflect transmitted light to reduce the light amount reaching the left/right eye. Therefore, “operation of opening the left/right filter” and “operation of closing the left/right filter” include all operations of increasing/decreasing the light amount reaching the left/right eye through the left/right filter.

### Embodiment 1

### 1. Overall Structure of Video System

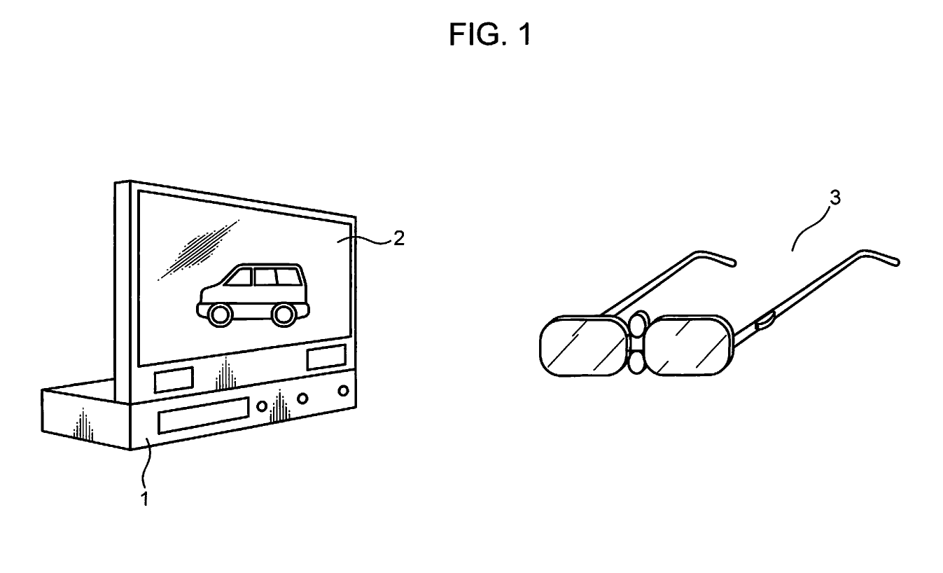

FIG. 1 shows a configuration of a video system including a video player 1 which plays data of contents to make a video stereoscopically perceived, a display device 2 which displays the video in response to a video signal which is played and output by the video player 1, and an eyeglass device 3 used to view the video which is displayed on the display device 2. In the present embodiment, a viewer stereoscopically views and perceives the video displayed on the display surface of the display device 2 through the eyeglass device 3.

The display device 2 displays the video in response to the video signal output from the video player 1. The display device 2 may include, for example, a device with a plasma display panel, a liquid crystal panel or a CRT, a device with an organic electroluminescence, or another device configured to allow the viewer to view the video in response to the stereoscopic video signal.

For convenience of the following descriptions, pairing has been already performed between the video player 1 and the eyeglass device 3. Accordingly, the video player 1 and the eyeglass device 3 have been set up so that bidirectional packet communication between the video player 1 and the eyeglass device 3 is available. The video player 1 has acquired information such as an IP address of the eyeglass device 3. Likewise, the eyeglass device 3 has acquired information such as an IP address of the video player 1. It should be noted that a specific communication method has been set in advance if there is infrared communication between the video player 1 and the eyeglass device 3.

### <1-1. Configuration of Video Player>

A configuration of the video player 1 is described hereinafter with the accompanying drawings.

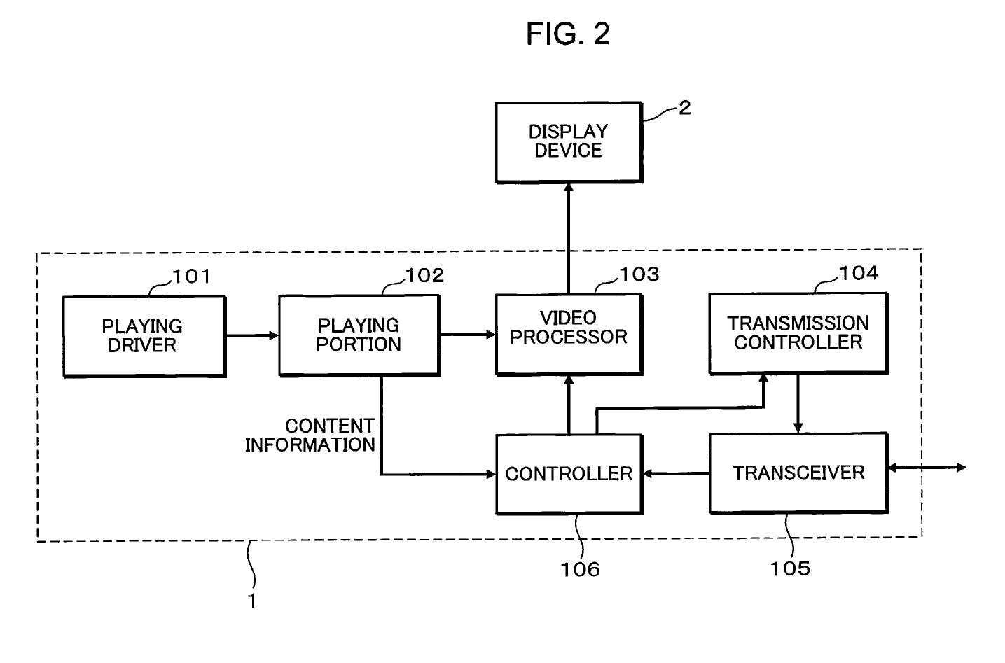

FIG. 2 is a schematic block diagram of the video player 1 according to the present embodiment.

The video player 1 according to Embodiment 1 includes a playing driver 101, a playing portion 102, a video processor 103, a transmission controller 104, a transceiver 105 and a controller 106.

The playing driver 101 includes a head (not shown) configured to read data of contents, which are coded in a predetermined format, from a recording medium. The playing driver also includes a motor (not shown) configured to rotate the recording medium. The playing driver 101 outputs the read data of contents to the playing portion 102.

The playing driver 101 outputs the coded data of contents. The playing portion 102 performs processes to decode the data of contents, which have been output from the playing driver 101. The playing portion 102 outputs the decoded data of contents to the video processor 103. It should be noted that, for convenience of the descriptions, the data of contents subjected to the decoding processes are referred to as “decoded data”. The playing portion 102 also outputs content information, which is the meta-information of the decoded data of contents, to the controller 106. The content information may include, for example, time information about the playing period of the data of contents and alike.

The video processor 103 performs signal processes associated with display of a stereoscopic video. The video processor 103 executes the video processes on the decoded data to generate and output video signals for displaying the stereoscopic video on the display device 2. In the following descriptions, the video signal for displaying a left frame image to be viewed by a left eye is referred to as the “L signal”. The video signal for displaying a right frame image to be viewed by a right eye is referred to as the “R signal”.

In a specific embodiment, the video processor 103 detects the L and R signals from the decoded data to generate the video signals, so that the left and right frame images generated in response to the detected L and R signals are alternately displayed on the display device 2, respectively. After performing the signal processes associated with the display of the stereoscopic video, the video processor 103 generates an output signal, which conforms to a signal input method of the display device 2. After that, the video processor 103 outputs the generated output signal to the display device.

It should be noted that the video processor 103 may have a function to change the signal processes on the decoded data, which have been output from the playing portion 102, in response to a control signal from the controller 106. For example, the video processor 103 determines whether the decoded data are subjected to signal processes for generating a video signal to be displayed as a stereoscopic video on the display device 2 (hereinafter referred to as a 3D video signal) or to signal processes for generating a video signal to be displayed as a two-dimensional video on the display device 2 (hereinafter referred to as a 2D video signal), on the basis of the control signal from the controller 106.

It should be noted that the video processor 103 may execute other processes than the aforementioned processes. For example, the video processor 103 may perform processes to adjust colors of the video to be displayed in accordance with display characteristics of the display device 2 or interpolating images between frames of the video data subjected to the decoding processes by the playing portion 102 to thereby increase the frame rate of the video.

The L and R signals may be automatically generated from the data of contents, which have been decoded by the playing portion 102. The video processor 103 may alternately output the automatically generated L and R signals to the display device 2.

The transmission controller 104 generates a synchronization signal in synchronism with the L and R signals generated by the video processor 103 in response to the control signal from the controller 106. The transmission controller 104 outputs the generated synchronization signal to the transceiver 105. The term “synchronization signal” means a control signal which associates the output timings of the L and R signals from the video processor 103 to the display device 2 with opening/closing timings of the left and right filters of the eyeglass device 3. For example, if the L signal is output from the video processor 103 to the display device 2, the eyeglass device 3 performs control to open the left filter and close the right filter in response to the synchronization signal. If the R signal is output from the video processor 103 to the display device 2, the eyeglass device 3 performs control to open the right filter and close the left filter in response to the synchronization signal.

The transceiver 105 transmits the synchronization signal generated by the transmission controller 104 to the eyeglass device 3 via a wireless communication path. The transceiver 105 receives remaining charge information about remaining battery charge of the eyeglass device 3 from the eyeglass device 3 to output the remaining charge information to the controller 106. The wireless communication path may be in a communication format by means of infrared light or in a communication format by means of a wireless LAN defined in IEEE 802.11, zigbee or Bluetooth. It should be noted that the wireless communication path is not limited to the aforementioned communication formats. The wireless communication path may be in another communication format which allows bidirectional communication with the eyeglass device 3. In the present embodiment, the transceiver 105 is exemplified as the second transceiver.

The controller 106 outputs the control signal to the video processor 103 and the transmission controller 104, so that the viewer views the data of contents as the 2D or 3D video signal. For example, the controller 106 generates the control signal on the basis of the remaining charge information received by the transceiver 105 and the content information output from the playing portion 102. Then, the controller 106 outputs the generated control signal to the video processor 103 and the transmission controller 104. A method for generating the control signal on the basis of the remaining charge information in the controller 106 is described hereinafter.

### <1-2. Configuration of Eyeglass Device>

A configuration of the eyeglass device 3 is described hereinafter with reference to the accompanying drawings.

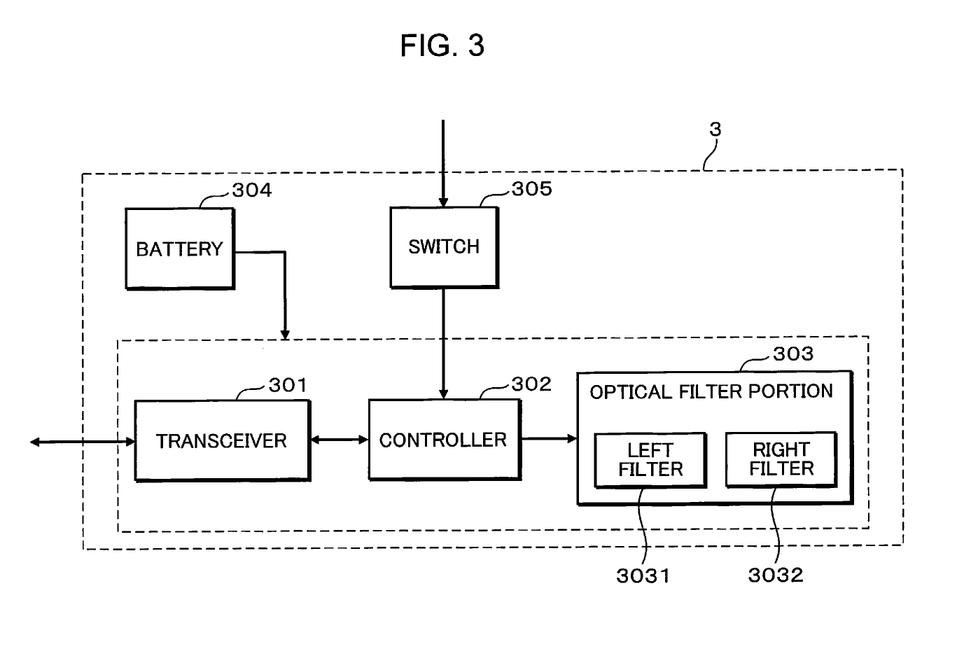

FIG. 3 is a schematic block diagram of the eyeglass device 3 according to the present embodiment.

The eyeglass device 3 includes a transceiver 301, a controller 302, an optical filter portion 303, a battery 304 and a switch 305.

The transceiver 301 receives the synchronization signal transmitted from the video player 1 via the wireless communication path. The transceiver 301 outputs the received synchronization signal to the controller 302. The controller 302 outputs information about battery charge remaining in the battery 304, and then the transceiver 301 transmits the information about the remaining battery charge to the video player 1 via the wireless communication path. The wireless communication path may be in a communication format by means of infrared light or a communication format by means of a wireless LAN defined in IEEE 802.11, zigbee or Bluetooth. It should be noted that the wireless communication path is not limited to the aforementioned communication formats. The wireless communication path may be in another communication format which allows bidirectional communication with the eyeglass device 3. In the present embodiment, the transceiver 301 is exemplified as the first transceiver.

The controller 302 controls the entire eyeglass device 3 according to programs recorded in a non-volatile recording medium (not shown). The controller 302 generates a control signal to control the optical filter portion 303 in response to the synchronization signal, which has been output from the transceiver 301. For example, the controller 302 generates a control signal in response to the synchronization signal to control the optical filter portion 303 such that the left filter 3031 opens whereas the right filter 3032 closes while a video in response to the L signal is displayed on the display device 2. The controller 302 generates a control signal in response to the synchronization signal to control the optical filter portion 303 such that the right filter 3032 opens whereas the left filter 3031 closes while a video in response to the R signal is displayed on the display device 2.

The controller 302 has a function to control the battery 304 so that the battery 304 starts power supply when the controller receives a power supply signal from the switch 305. It should be noted that the controller 302 continues to receive the power supply from the battery 304 so that the controller 302 may receive the power supply signal from the switch 305 while the controller 302 is put on standby. Alternatively, the controller 302 may receive power supply from another power supply device.

The controller 302 acquires the remaining charge information about the battery charge remaining in the battery 304 and outputs the remaining charge information to the transceiver 301. The remaining charge information acquired by the controller 302 is described hereinafter. It should be noted that a method for acquiring the remaining battery charge by the controller 302 may be implemented according to a known method for detecting the remaining battery charge such as measurement for a voltage of the battery 304.

The optical filter portion 303 is situated in front of the left and right eyes of a viewer wearing the eyeglass device 3 to adjust the transmitted light amounts to the left and right eyes. The optical filter portion 303 includes the left and right filters 3031, 3032 in front of the left and right eyes of the viewer, respectively. The optical filter portion 303 appropriately controls the operations of the left and right filters 3031, 3032 to give a desired optical effect (to make the video stereoscopically perceived) to the user of the eyeglass device 3 in response to the control signal output from the controller 302.

The battery 304 used as a power supply of the eyeglass device 3 performs power supply to the transceiver 301, the controller 302, and the optical filter portion 303 on the basis of an instruction from the controller 302. For example, a portable battery, which is small enough to be embedded in the eyeglass device 3, such as a primary or secondary battery, is suitably used as the battery 304.

The user of the eyeglass device 3 may operate the switch 305. The switch 305 operated by the user outputs the power supply signal to start the power supply to the controller 302. The switch 305 may be, for example, a button configured to be pressed.

### 2. Contents of Operations

Operations of the video player 1 and the eyeglass device 3 are described hereinafter with reference to the accompanying drawings.

### <2.1. Operation Flow for Transmitting Remaining Charge Information>

An operation flow for the eyeglass device 3 to transmit the remaining charge information is described hereinafter with reference to the accompanying drawings.

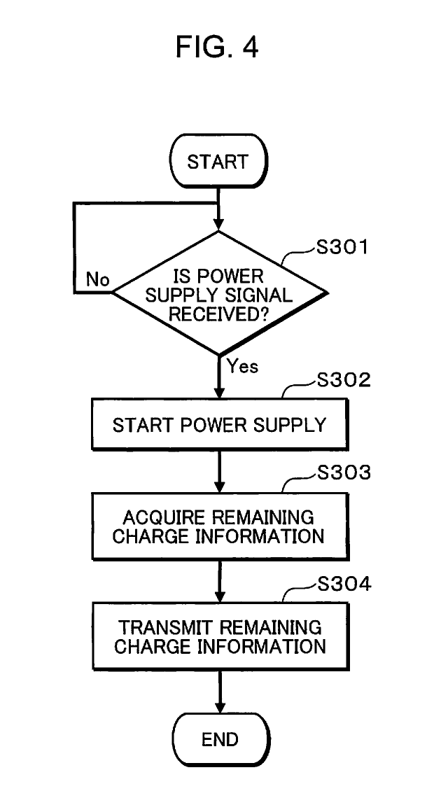

FIG. 4 is a flow chart schematically showing the operation for transmitting the remaining charge information by the eyeglass device 3. If the switch 305 is pressed by the user, the switch 305 outputs the power supply signal to the controller 302. Then, Step S301 is executed.

### (Step S301)

The controller 302 is in a standby mode during which the controller 302 may receive the power supply signal from the switch 305. Whenever the controller 302 detects the input of the power supply signal from the switch 305, the controller 302 executes Step S302. It should be noted that the controller 302 keeps the standby mode unless the power supply signal is input from the switch 305.

### (Step S302)

If the power supply signal is input from the switch 305, the controller 302 controls the power supply from the battery 304 toward the entire eyeglass device 3. For example, the controller 302 controls the power supply to the transceiver 301 and the optical filter portion 303. After the present step, each module of the eyeglass device 3 becomes operable. After the control for starting the power supply from the battery 304 to the entire eyeglass device 3, Step S303 is executed.

### (Step S303)

After the battery 304 starts the power supply to the entire eyeglass device 3, the controller 302 acquires the remaining charge information about battery charge which remains in the battery 304. After the remaining charge information is acquired, the controller 302 outputs the remaining charge information to the transceiver 301. Thereafter, Step S304 is executed.

### (Step S304)

The transceiver 301 transmits the remaining charge information input from the controller 302 to the video player 1 by means of wireless communication defined in, for example, IEEE 802.11, zigbee or Bluetooth.

Throughout the aforementioned operation flow, the video player 1 may acquire the remaining charge information about the remaining battery charge of the eyeglass device 3, for example, at a timing to start viewing the data of contents if the viewer presses the switch 305. Therefore, the video player 1 may adjust the playing operation in response to the remaining battery charge of the eyeglass device 3 from the playing start time of the data of contents.

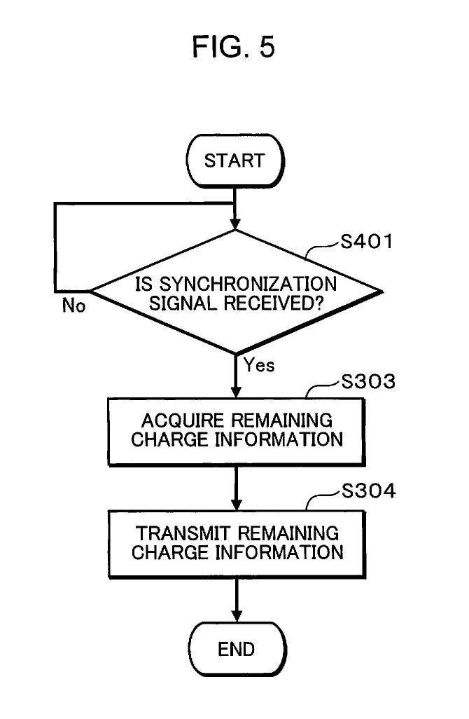

FIG. 5 is a schematic flow chart showing another operation for transmitting the remaining charge information by the eyeglass device 3. The same steps as in FIG. 4 are designated by the same numbers. Detailed descriptions of the same steps are omitted.

In the flow chart shown in FIG. 5, the eyeglass device 3 transmits the remaining charge information if the transceiver 301 receives the synchronization signal, which is used to control the optical filter portion 303. If the switch 305 is pressed by the user to start power supply from the battery 304 to the entire eyeglass device 3, Step S401 is executed.

### (Step S401)

The transceiver 301 detects whether or not the synchronization signal is received from the video player 1 via wireless communication defined in, for example, IEEE 802, 11, zigbee or Bluetooth. If the transceiver 301 receives the synchronization signal, Step S303 is executed. Unless the transceiver 301 receives the synchronization signal, the controller 302 waits for receiving the synchronization signal.

Throughout the aforementioned operation flow, the eyeglass device 3 may transmit the remaining charge information to the video player 1 as soon as the synchronization signal is received from the video player 1.

It should be noted that the transmission timing of the remaining charge information by the eyeglass device 3 is not limited to the timing when the synchronization signal is received. The eyeglass device 3 may transmit the remaining charge information at the timing when a special playing signal associated with special play mode (for example, a fast-forward playing signal such as 1.5-times-speed or double-speed play mode, a signal to start playing the data of contents, a signal to rewinding-play the data of contents or a chapter skip signal) is received from the video player 1. In this case, the synchronization signal described in the context of FIG. 5 is replaced with the aforementioned special playing signal. Alternatively, the eyeglass device 3 may transmit the remaining charge information at the timing when an end signal to end the aforementioned special play mode is received.

It should be noted that the operations described with reference to FIGS. 4 and 5 may be combined with each other.

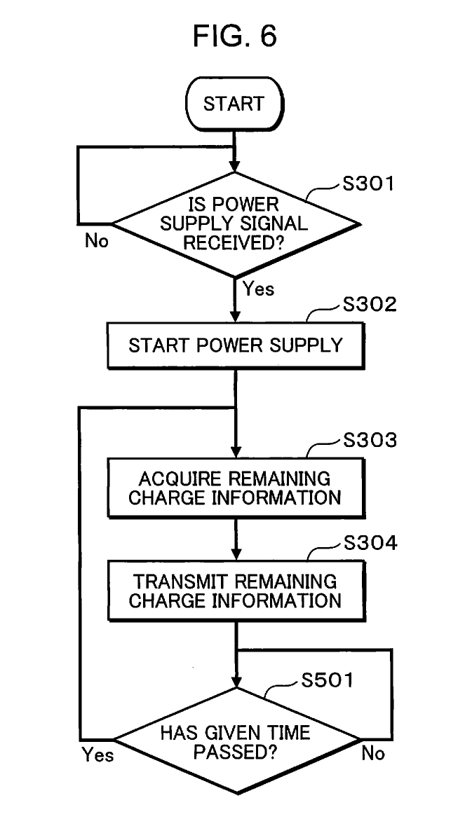

FIG. 6 is a schematic flow chart describing yet another operation to transmit the remaining charge information from the eyeglass device 3. The same steps as described with reference to FIGS. 4 and 5 are designated by the same numbers. Detailed descriptions of the same steps are omitted.

In the flow chart shown in FIG. 6, the eyeglass device 3 transmits the remaining charge information at given time intervals after power supply is started under the control of the controller 302.

### (Step S501)

After Step S304, the controller 302 determines whether or not the given time interval passes. If the given time interval passes, Step S303 is executed. In Step S303, the controller 302 acquires the remaining charge information. Unless the given time interval passes, the controller 302 continues the standby mode until the given time interval passes. The “given time interval” may be any period such as 20 or 30 minutes. A shorter time interval (e.g., 5 minutes) may be set as the “given time interval” to make the video player 1 more frequently control the playing operation.

### <2-2. Flow of Playing Operation of Video Player>

A playing operation flow of the video player 1 is described hereinafter with reference to the accompanying drawings.

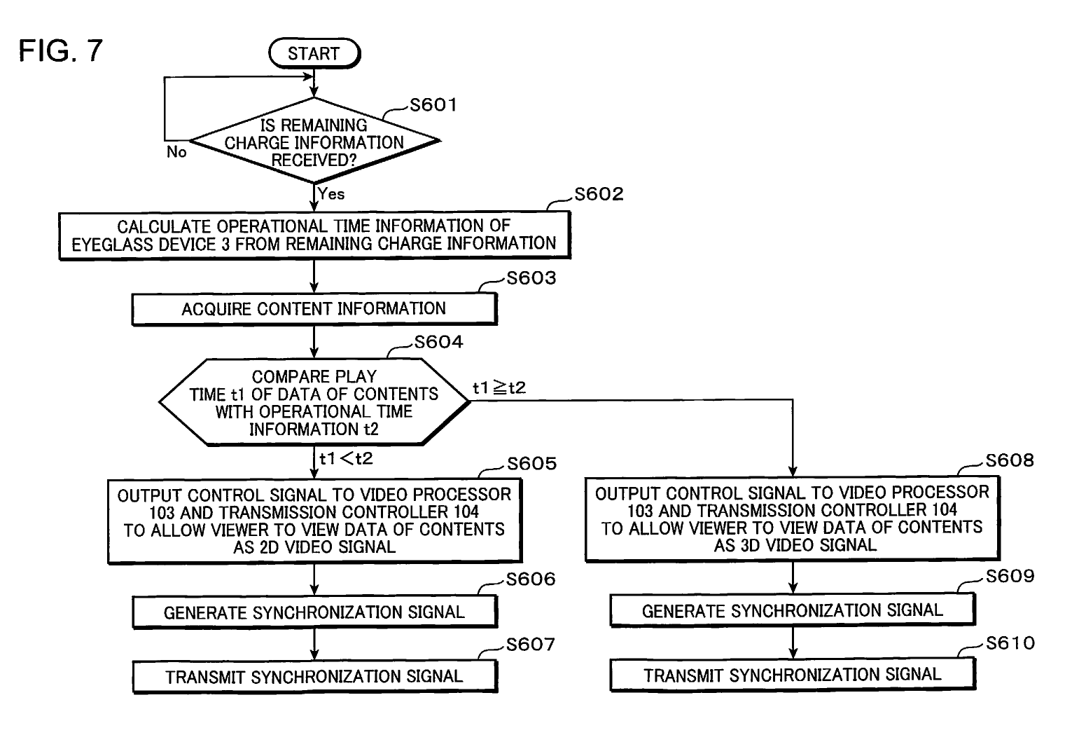

FIG. 7 is a flow chart schematically showing an operation to play the data of contents by the video player 1 acquiring the remaining charge information.

### (Step S601)

The transceiver 105 detects whether or not the remaining charge information is received from the eyeglass device 3 via wireless communication defined in, for example, IEEE 802.11, zigbee or Bluetooth. If the remaining charge information is received, the transceiver 105 outputs the received information about the remaining charge to the controller 106. Then, Step S602 is executed. Unless the remaining charge information is received, the transceiver 105 continues to wait for receiving the remaining charge information.

### (Step S602)

The controller 106 calculates information (hereinafter referred to as “t1”) about the operation time of the eyeglass device 3 based on the remaining charge information, which has been output from the transceiver 105. For example, if the remaining battery charge of the eyeglass device 3 is 100%, “t1” may be set to 10 hours in advance for the video player 1. In this case, if the controller 106 acquires the remaining charge information which defines that the remaining battery charge of the eyeglass device 3 is 50%, the controller 106 calculates t1 as 5 hours. It should be noted that the calculation of “t1” by the controller 106 is not limited to the aforementioned method. The controller 106 may use any method to acquire the “t1” of the eyeglass device 3 on the basis of the remaining charge information.

For example, in the present embodiment, the transceiver 301 of the eyeglass device 3 may transmit an amount of energy (Wh) of the battery 304 as the remaining charge information. For example, the controller 106 of the video player 1 may store information in advance about the power (W) to be consumed by the eyeglass device 3. Alternatively, the controller 106 may acquire the information about the power (W) to be consumed by the eyeglass device 3 via Internet communication. Alternatively, the transceiver 301 of the eyeglass device 3 may transmit information about the power (W) to be consumed by the eyeglass device 3 to the video player 1 if the user operates the switch 305. After the controller 106 acquires the remaining charge information, for example, the controller 106 may divide the energy amount (Wh) of the battery 304 by the consumed power (W) to calculate operational time information “t”.

### (Step S603)

The controller 106 acquires content information including playing period information (hereinafter referred to as “t2”) of the data of contents, which have been output from the playing portion 102.

### (Step S604)

Subsequently, the controller 106 compares “t1” with “t2”. If the controller 106 determines that “t1” is larger as a result of the comparison between “t1” and “t2”, Step S608 is executed. On the other hand, unless the controller 106 determines that “t2” is shorter than “t1”, Step S605 is executed.

### (Step S605)

The controller 106, which determines that “t1” is larger than “t2”, outputs a control signal to the video processor 103 and the transmission controller 104, so that the viewer views the decoded data output from the playing portion 102 as a 2D video. The video processor 103 generates a video signal in response to the control signal from the controller 106, and then outputs the generated video signal to the display device 2.

### (Step S606)

The transmission controller 104 generates the synchronization signal in response to the control signal from the controller 106. The transmission controller 104 outputs the generated synchronization signal to the transceiver 105.

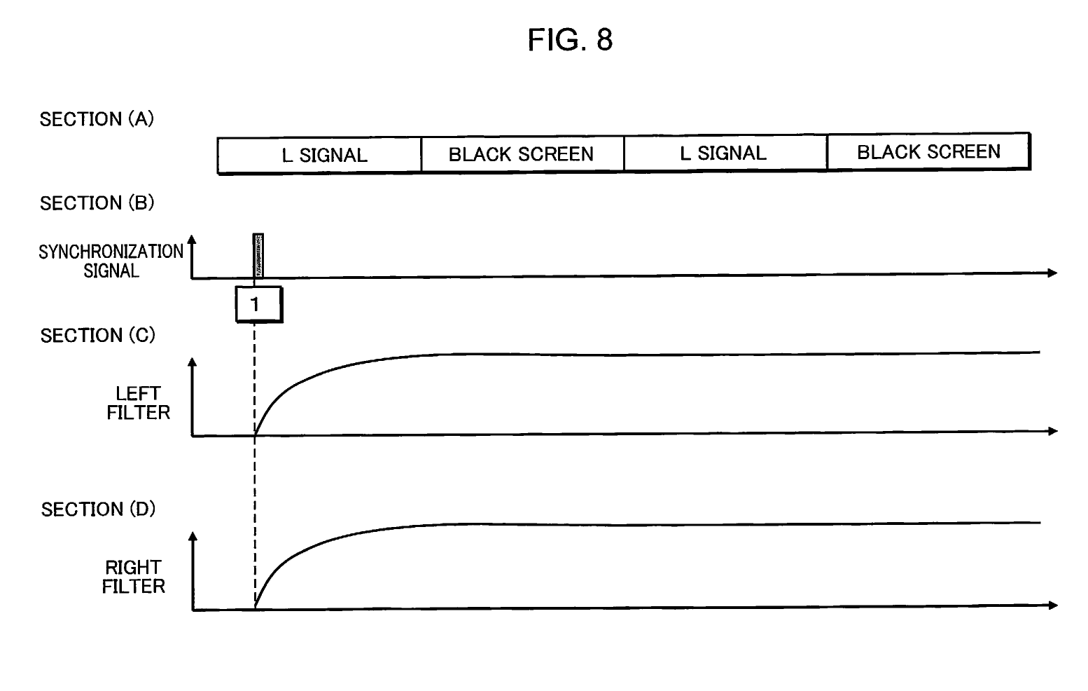

FIG. 8 is a timing chart showing a relationship among the video signal generated by the video processor 103, the synchronization signal generated by the transmission controller 104 and the left and right filters 3031, 3032 which are operated in response to the synchronization signal.

The controller 106 outputs the control signal to the video processor to generate the video signal shown in the section (a) of FIG. 8. The video processor 103 outputs the L signal (without outputting the R signal) at a specific cycle period (for example, 60 Hz) in response to the control signal output from the controller 106. In addition, the video processor 103 generates a video signal to display a black screen, which is entirely composed of black, between the preceding L signal and the subsequent L signal. Alternatively, the video processor 103 may generate the R signal instead of the L signal. Further alternatively, the video processor 103 may generate an intermediate signal to compensate motion on the basis of the preceding L signal (or R signal) and the subsequent L signal (or R signal), instead of the black screen. As a result, the viewer may view a smooth moving image.

The controller 106 generates the control signal to the transmission controller 104 so that the transmission controller 104 generates the synchronization signal shown in the section (b) of FIG. 8. The transceiver 105 transmits the synchronization signal shown in the section (b) of FIG. 8 to the transceiver 301 of the eyeglass device 3. If the transceiver 301 of the eyeglass device 3 receives the synchronization signal shown in the section (b) of FIG. 8, the left and right filters 3031, 3032 are operated as shown in the sections (c) and (d) of FIG. 8. It should be noted that a pulse signal “1” included in the synchronization signal defines an operation of the left and right filters 3031, 3032 so that the left and right filters 3031, 3032 keep the opened orientation after the transceiver 301 of the eyeglass device 3 receives the pulse signal “1”. If the left and right filters 3031, 3032 are kept open (i.e., an operation to keep an increased light amount, which reaches the eyes of the viewer), the viewer may view the data of contents as the 2D video signal. As a result, the left and right filters are less frequently operated (i.e., the battery consumption goes down). Therefore it becomes less likely that the eyeglass device 3 runs out of the battery 304.

It should be noted that a control method which allows the viewer to view the data of contents as the 2D video signal is not limited to the aforementioned configuration. For example, the controller 106 may output a control signal to the video processor 103 so that the video processor 103 continuously outputs one of the L and R signals. The controller 106 may output a control signal to the transmission controller 104 so that the transmission controller generates a synchronization signal which allows the left and right filters 3031, 3032 to open at the same time in synchronization with the output of the one of the L and R signals. Such control over the optical filter portion 303 may make the left and right filters 3031, 3032 less frequently operated, in comparison with the optical filter portion 303 used to view the 3D video, which requires the left and right filters 3031, 3032 alternately opened/closed in synchronization with the outputs of the L and R signals. Thus it becomes less likely that the eyeglass device 3 runs out of the battery 304.

### (Step S607)

The transceiver 105 transmits the synchronization signal, which has been output from the transmission controller 104, to the eyeglass device 3 by means of wireless communication defined in, e.g., IEEE 802.11, zigbee or Bluetooth.

### (Step S608)

If the controller 106 determines that “t1” is not shorter than “t2”, the controller 106 outputs the control signal to the video processor 103 and the transmission controller 104 so that the viewer views the decoded data output from the playing portion 102 as the 3D video signal. The video processor 103 generates and outputs a video signal to the display device 2 in response to the control signal from the controller 106.

### (Step S609)

The transmission controller 104 generates the synchronization signal in response to the control signal from the controller 106. The transmission controller 104 outputs the generated synchronization signal to the transceiver 105.

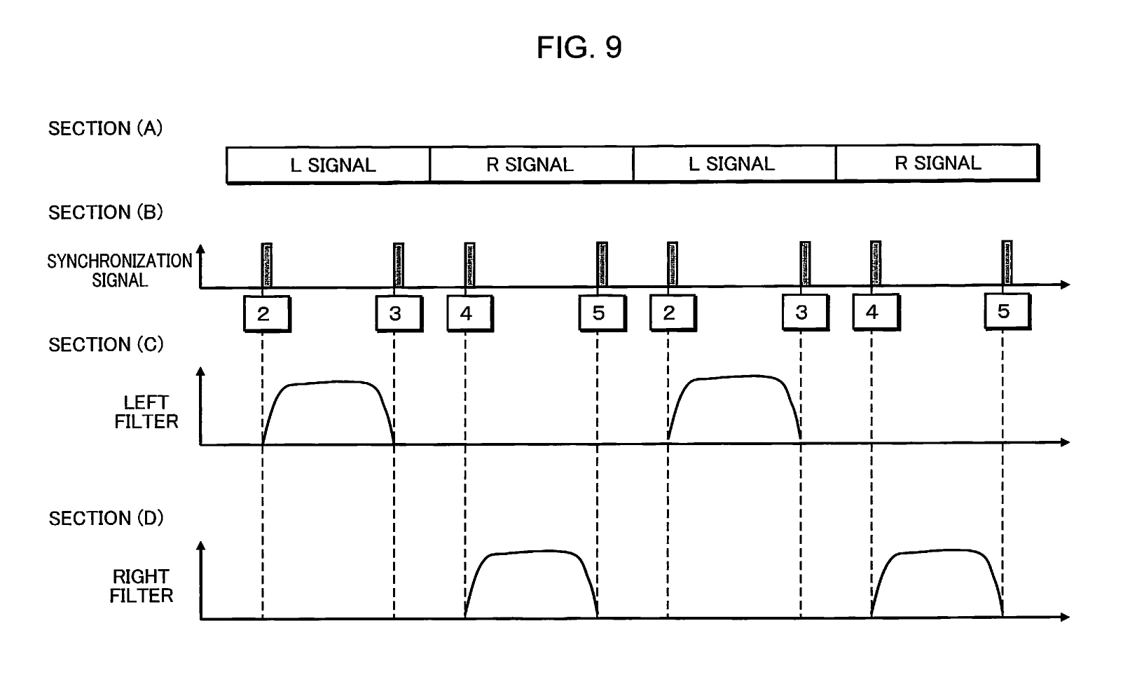

FIG. 9 is a timing chart showing a relationship among the video signal generated by the video processor 103, the synchronization signal generated by the transmission controller 104 and the left and right filters 3031, 3032 which are operated in response to the synchronization signal.

The controller 106 outputs a control signal to the video processor 103 so that the video processor 103 generates a video signal as shown in the section (a) of FIG. 9. The controller 106 generates a control signal for the transmission controller 104 so that the transmission controller 104 generates the synchronization signal shown in the section (b) of FIG. 9. If the eyeglass device 3 receives the synchronization signal shown in the section (b) of FIG. 9, the left and right filters 3031, 3032 are operated as shown in the sections (c) and (d) of FIG. 9, respectively. It should be noted that a pulse signal “2” in the synchronization signal defines an operation to open the left filter 3031. A pulse signal “3” in the synchronization signal defines an operation to close the left filter 3031. A pulse signal “4” in the synchronization signal defines an operation to open the right filter 3032. A pulse signal “5” in the synchronization signal defines an operation to close the right filter 3032.

### (Step S610)

The transceiver 105 transmits the synchronization signal, which has been output from the transmission controller 104, to the eyeglass device 3 by means of wireless communication defined in, e.g., IEEE 802.11, zigbee or Bluetooth.

Throughout the aforementioned operation flow, the video player 1 appropriately controls to play the data of contents before or while the data of contents is viewed. As a result, it becomes less likely that the eyeglass device 3 runs out of the battery while the data of contents is played as a 3D video signal. Thus, such a failure that the viewer suddenly fails to view the 3D video is less likely to occur.

### Embodiment 2

The video player 1 described in the context of Embodiment 1 switches between a 2D mode which allows the viewer to view the video displayed on the display device 2 as the 2D video and a 3D mode which allows the viewer to view the video displayed on the display device 2 as the 3D video on the basis of the remaining charge information, which has been transmitted from the eyeglass device 3. As a result, it becomes less likely that shortage of charge remaining in the battery of the eyeglass device 3 makes the viewer suddenly failed to view the 3D video.

The viewer may, however, view a part of the data of contents as the 3D video even if the remaining battery charge of the eyeglass device 3 is not sufficient to allow the viewer to view the entire data of contents as the 3D video. Therefore, a video system described in Embodiment 2 allows a viewer to view a part of the data of contents corresponding to a 2D video signal on the basis of the remaining charge information transmitted from the eyeglass device 3 whereas the video system allows the viewer to view other parts (e.g., a climax scene and alike) corresponding to a 3D video signal.

The video system according to Embodiment 2 is described hereinafter with reference to the accompanying drawings. It should be noted that configurations of the video player 1 and the eyeglass device 3 according to Embodiment 2 are generally the same as those described in the context of Embodiment 1, so that descriptions about the same components are omitted. Embodiment 2 is different in the controller 106 from Embodiment 1. The controller 106 is described hereinafter in detail.

### <Controller>

The controller 106 compares the playing period of the data of contents with the operational time information, on the basis of the remaining charge information, which has been output from the transceiver 105, and the content information, which has been output from the playing portion 102. In addition, the controller 106 temporally switches from the control signal for processing the data of contents as the 3D video signal to the control signal for processing the data of contents as the 2D video signal if the operational time information is shorter than the playing period. Subsequently the controller 106 outputs the control signal corresponding to the 2D video signal to the video processor 103 and the transmission controller 104.

### <Operation Flow of Controller>

An operation flow of the controller 106 is described hereinafter with reference to the accompanying drawings.

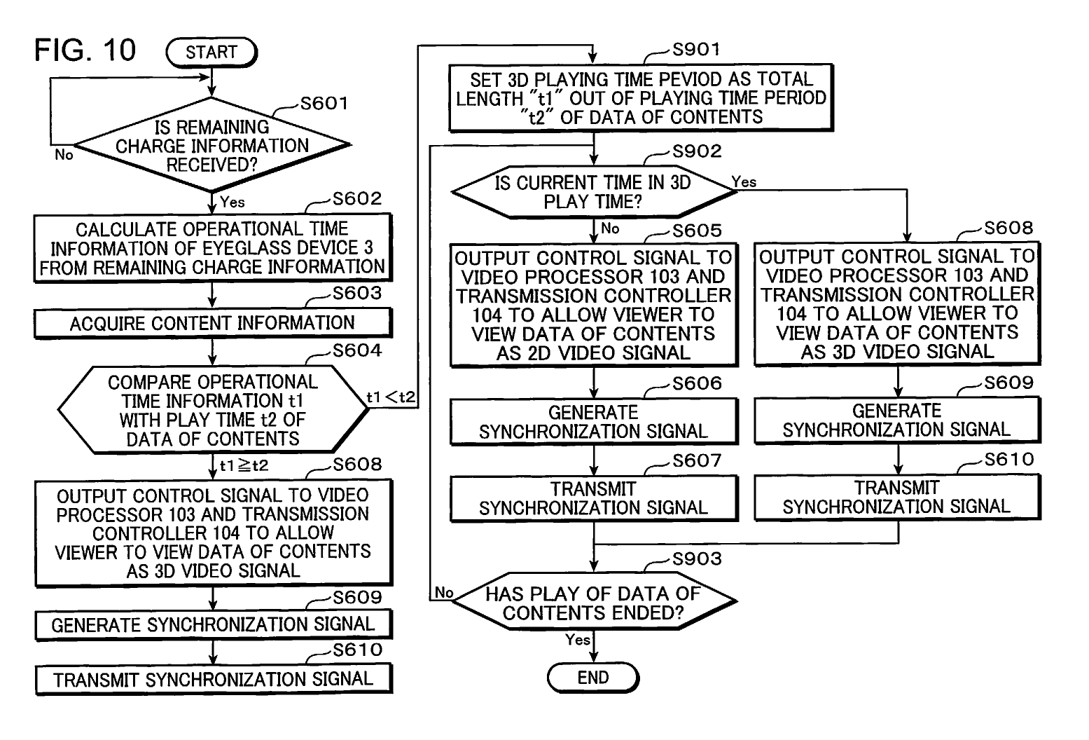

FIG. 10 is a schematic flow chart showing an operation of the controller 106. The same steps as those shown in FIG. 7 and described in the context of Embodiment 1 are designated by the same numbers. Detailed descriptions of the same steps are omitted. For convenience of the descriptions, a time period during which the controller 106 outputs the control signal to the video processor 103 and the transmission controller 104 so as to allow the viewer to view the data of contents as the 2D video is referred to as the 2D playing period. A time period during which the controller 106 outputs the control signal to the video processor 103 and the transmission controller 104 so as to allow the viewer to view the data of contents as the 3D video is referred to as the 3D playing period.

### (Step S901)

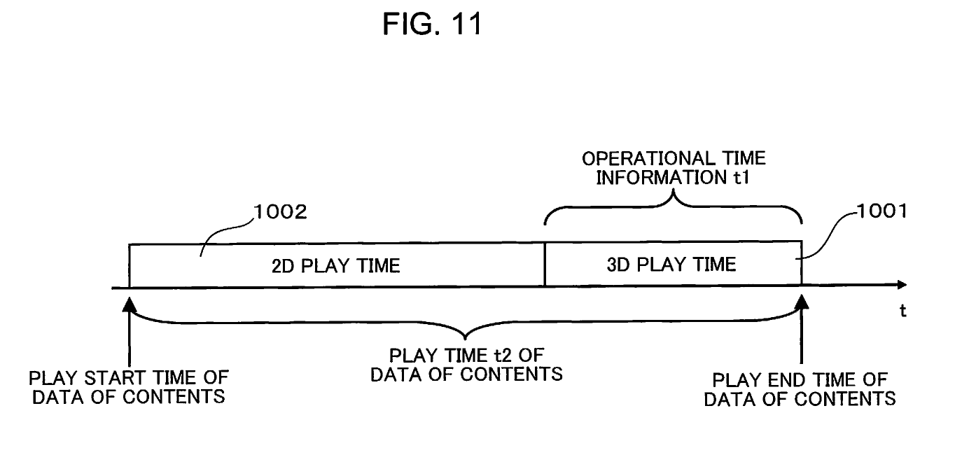

In Step S604, if the controller 106 determines that “t1” is shorter than “t2”, the controller 106 sets the 3D playing period such that the playing period “t2” of the data of contents is divided into a total length “t1” of the 3D playing period and the remaining length of 2D playing period (i.e., a time length of “t2”−“t1”). For example, as shown in FIG. 11, the controller 106 sets a time period from a play end time of the data of contents back to a time by the operational time information “t1” (corresponding to a time period 1001 in FIG. 11) as the 3D playing period out of the playing period “t2” of the data of contents. The controller 106 sets a time period other than the time period, which is set as the 3D playing period (corresponding to a time period 1002 in FIG. 11), as the 2D playing period (i.e., a time period from a play start time of the data of contents forward to a time by the time period given by “t1”-“t2”).

### (Step S902)

The controller 106 determines whether or not the current time, at which the data of contents are played, is in the 3D playing period. If the controller 106 determines that the current time is in the 3D playing period, Step S608 is executed. On the other hand, if the controller 106 determines that the current time is not in the 3D playing period, Step S605 is executed. Step S903 is executed after the video player 1 performs processes from Step S608 to S610 or performs processes from Step S605 to S607.

### (Step S903)

The controller 106 determines whether or not the play of the data of contents ends. If the play of the data of contents ends, the controller 106 also ends the operation. Unless the play of the data of contents ends, Step S902 is executed.

Throughout the aforementioned operation flow, even if the operational time information is shorter than the playing period of the data of contents, the viewer may view a part of the data of contents as the 3D video as long as the eyeglass device 3 is operable.

It should be noted that the setting operation by the controller 106 in Step S901 may be performed before the data of contents are played, as described above. Alternatively, the setting operation by the controller 106 in Step S901 may be appropriately performed while the data of contents are played.

### <Setting Method by Controller in Step S901>

A setting method executed by the controller 106 in Step S901 is described hereinafter with reference to the accompanying drawings.

### <Play of Digested Portion According to 3D Video Signal>

The controller 106 may preferentially set digested portions of the data of contents as the 3D playing period.

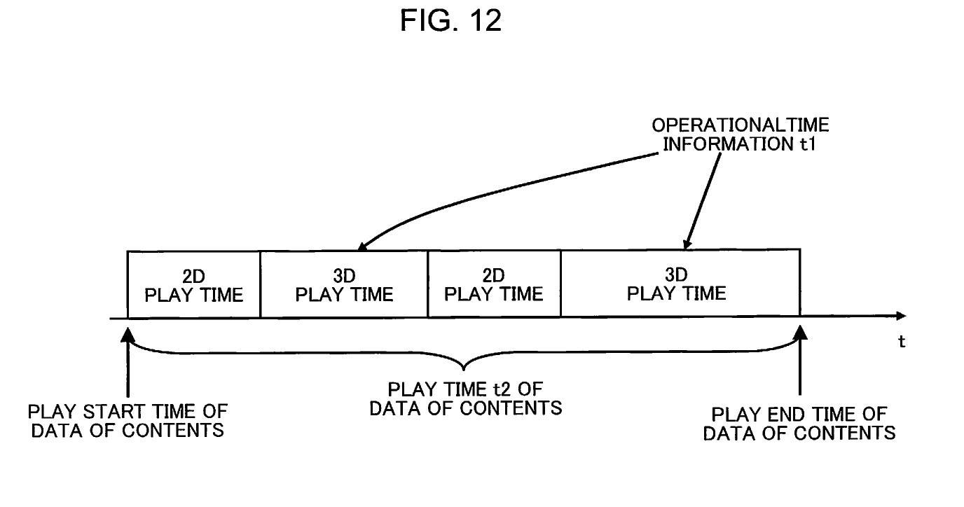

FIG. 12 is a schematic view showing a method with which the controller 106 sets the 3D playing period to the digested portions of the data of contents, respectively.

As shown in FIG. 12, the controller 106 may intermittently set the 3D playing period in the entire data of contents. According to the intermittent setting, the display device 2 alternately displays the video, which has been generated in response to the 2D video signal, and the video, which has been generated in response to the 3D video signal. For example, the video corresponding to the digested portion is displayed in response to the 3D video signal.

It should be noted that the controller 106 preferably analyzes the data of contents to extract the digested portions. In this case, the controller 106 extracts the data portions corresponding to a high sound volume in the data of contents (a time period during which audio data included in the data of contents shows a sound volume, which is no less than a predetermined level) as the digested portions. Alternatively the controller 106 extracts the data portions corresponding to switching portions of the video as the digested portions. It should be noted that any known method may be suitably used as a method for extracting the digested portions by the controller 106.

It should be noted that, as described above, the controller 106 preferentially sets the digested portions as the 3D playing period. A part of portions identified as the digested portions by the controller 106 may be set as the 3D playing period. In this case, the controller 106 may also set a portion other than the digested portions as the 3D playing period.

If the data of contents includes the start and end times of the digested portions, which are held in, for example, the header portion of the data in advance, the controller 106 may read out the start and end times of the digested portions.

It should be noted that the controller 106 may compare the playing period of the digested portions with the operational time information. If the operational time information is shorter than the playing period of the digested portions, the controller 106 may preferentially set the digested portions, which are closer to the leading end of the data of contents, as the 3D playing period. For example, the controller 106 assigns the 3D playing period to time periods of the digest portions from the start time of the closest digest portion to the leading end of the data of contents by the operational time information in order of closeness from the leading end.

It should be noted that if the controller 106 compares the playing period of the digested portions with the operational time information and determines that the operational time information is shorter than the playing period of the digested portions, the controller 106 may preferentially set the digested portions which are closer to the terminal end of the data of contents as the 3D playing period. For example, the controller 106 assigns the 3D playing period to time periods of the digest portions from the end time of the closest digest portion to the terminal end of the data of contents by the operational time information in order of closeness from the terminal end.

It should be noted that if the data of contents include the start and end times of the digested portions and the priorities over the digested portions, which are held in, for example, the header portion of the data in advance, the controller 106 may preferentially set the digested portions having the higher priorities as the 3D playing period.

<Playing Data of Contents from Leading Portion by Time Period Represented by Operational Time Information as 3D Video Signal>

The controller 106 may set a time period from the leading end time of the data of contents forward to a time by the time period represented by the operational time information as the 3D playing period.

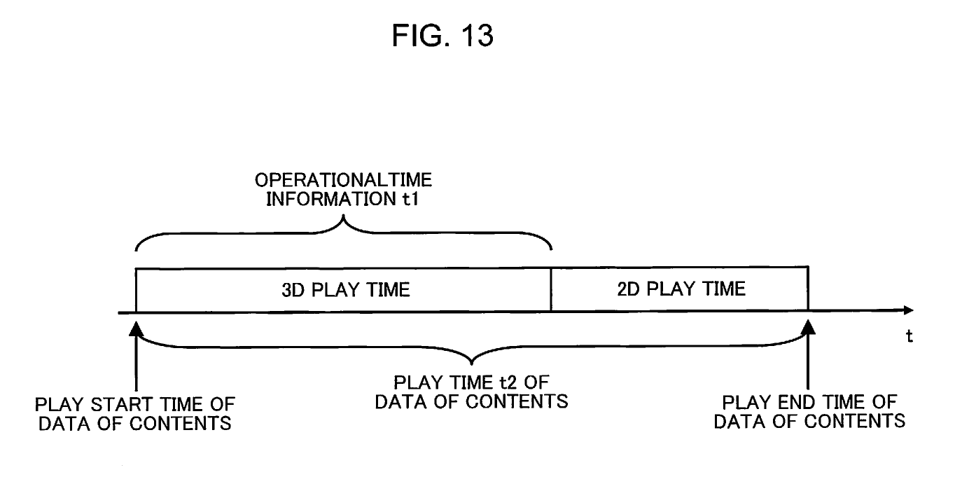

FIG. 13 is a schematic view showing a method with which the controller sets 3D playing period corresponding to the operational time information from the leading of the data of contents. Unlike the method shown in FIG. 12, the 3D playing period shown in FIG. 13 is set as a time period from the play start time of the data of contents forward to a time by the operational time information. On the other hand, the 2D playing period is set as a time period shorter by the 3D playing period than the playing period of the data of contents.

According to the aforementioned setting method, even if the operational time information “t1” is shorter than the playing period information “t2” of the data of contents, the viewer may view appropriate portions such as the digested portions as the 3D video.

### Embodiment 3

The video player 1 described in the context of Embodiment 2 switches between the 2D and 3D modes on the basis of the remaining charge information, which has been transmitted from the eyeglass device 3. Therefore the viewer wearing the eyeglass device 3 views a part of the data of contents as the 2D video and the other part of the data of contents as the 3D video. Accordingly, even if the operational time information “t1” is shorter than the playing period information “t2” of the data of contents, the viewer may view an appropriate portion such as the digested portion as the 3D video.

If the viewer requests a special play, the playing period of the data of contents, however, becomes shorter or longer. For example, if the viewer requests “fast-forward play” or “forward skip play”, the playing period of the data of contents is substantially shortened. On the other hand, if the viewer requests “rewind play”, “backward skip play” or “pausing”, the playing period of the data of contents is substantially elongated.

A video player described in the context of Embodiment 3 resets the 3D and 2D playing periods after the special play requested by the viewer.

The video player according to Embodiment 3 is described hereinafter with reference to the accompanying drawings. It should be noted that the video player 1 and the eyeglass device 3 according to Embodiment 3 are generally the same as the configurations described in the context of Embodiment 1 or 2. Descriptions about the same components are omitted. Embodiment 3 is different in the controller 106 from Embodiment 1 or 2. The controller 106 is described hereinafter in detail.

It should be noted that, for convenience of the descriptions, the video player 1 has already acquired the remaining charge information from the eyeglass device 3. The timing of the acquisition of the remaining charge information by the video player 1 is not particularly limited if the acquisition timing is before the special play is performed. For example, the video player 1 may acquire the remaining charge information, for example, when the user first sends a play signal to play the data of contents.

For convenience of the following descriptions, the video player 1 has acquired information representing that the playing period of the data of contents at the play start time is two hours and the operational time information of the eyeglass device 3 is one hour. The special playing signal received by the video player 1 defines 16-times speed of a fast-forward in the following descriptions. The special playing signal is used as a change signal for changing a playing operation by the playing portion 102 for a predetermined time period.

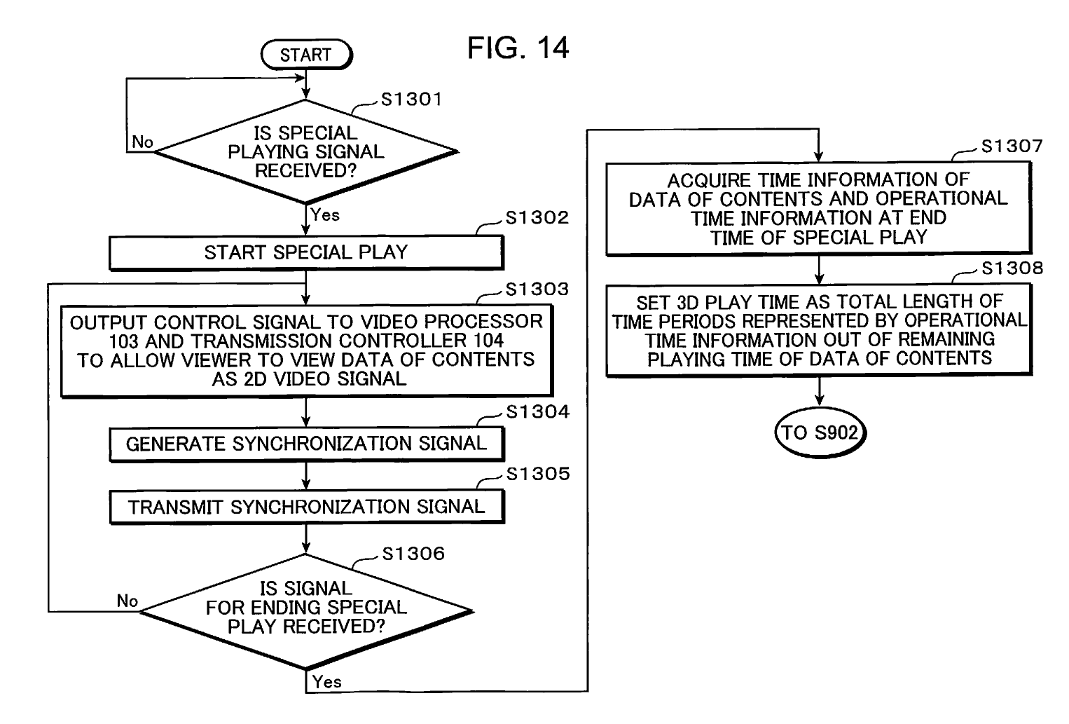

FIG. 14 is a flow chart showing an operation of the video player 1 according to the present embodiment, which receives the special playing signal.

### (Step S1301)

The transceiver 105 waits for receiving the special playing signal. If the transceiver 105 receives the special playing signal, Step S1302 is executed. Unless the special playing signal is received, the transceiver 105 continues to wait for receiving the special playing signal.

### (Step S1302)

The controller 106 causes the playing portion 102 to execute special play defined by the special playing signal which the transceiver 105 receives. For example, the controller 106 starts controlling the playing driver 101, the playing portion 102 and the video processor 103 such that the data of contents are displayed at a 16-times speed on the display device 2 from a portion of the data of contents at which the special play mode is instructed.

### (Step S1303)

The controller 106 outputs the control signal to the video processor 103 and the transmission controller 104 so that the viewer views the decoded data, which have been output from the playing portion 102, as a 16-times-speed of the 2D video during the special play mode. The video processor 103 generates the video signal in response to the control signal from the controller 106 and causes the display device 2 to display the 2D video.

### (Step S1304)

The transmission controller 104 generates the synchronization signal in response to the control signal from the controller 106. The transmission controller 104 outputs the generated synchronization signal to the transceiver 105.

### (Step S1305)

The transceiver 105 transmits the synchronization signal, which has been output from the transmission controller 104, to the eyeglass device 3 by means of wireless communication defined in, e.g., IEEE 802.11, zigbee or Bluetooth.

### (Step S1306)

The transceiver 105 checks whether or not an end signal for ending the special play mode is received. If the transceiver 105 receives the end signal, the transceiver 105 notifies the controller 106 of the end signal reception. Then, Step S1307 is executed. Unless the end signal is received, the transceiver 105 continues to wait for the end signal.

### (Step S1307)

The controller 106 notified of the end signal by the transceiver 105 acquires the remaining playing period of the data of contents and the operational time information of the eyeglass device 3 at the time of the end signal reception. Thereafter, Step S1308 is executed.

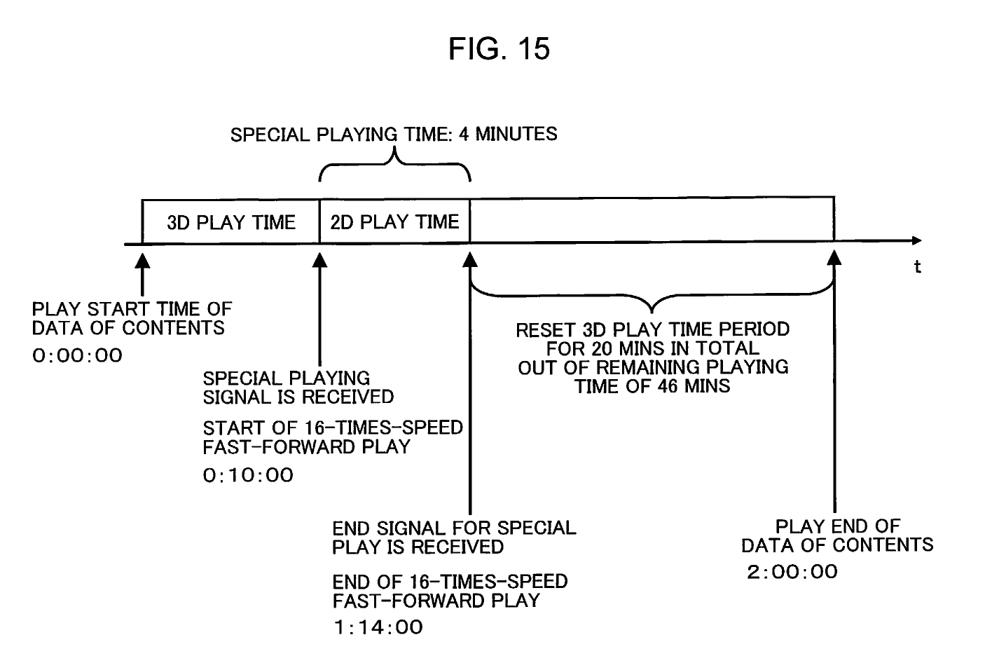

FIG. 15 is a schematic view showing an operation to acquire the time information in Step S1307.

As shown in FIG. 15, for example, at the time of “0:10:00” in the data of contents, the transceiver 105 receives the special playing signal to execute the 16-times-speed of the fast-forward operation. The video player 1 has plays the 3D video for 10 minutes from the play start in response to the 3D video signal. In addition, the special play mode is performed for 4 minutes, and normal play mode is resumed from the time of “1:14:00” in the data of contents. At this time, the controller 106 acquires time information showing that the remaining playing period of the data of contents is “46 minutes”. The controller 106 also acquires time information showing that the operational time information is “20 minutes”.

### (Step S1308)

The controller 106 sets the 3D playing period such that 20 minutes out of the remaining “46 minute” playing period of the data of contents are allocated to the 3D reproduction in total. Then, Step S902 described with reference to FIG. 10 is executed.

It should be noted that, the controller 106 may output the control signal to the video processor 103 and the transmission controller 104 during the special play mode so that the viewer views the decoded data, which have been output from the playing portion 102 as a 16-times-speed of the 2D video signal. In this case, once the end signal shown in FIG. 15 is received, the controller 106 may acquire time information representing that the operational time information is 16 minutes. Accordingly, in Step S1308, the controller 106 sets the 3D playing period such that “16 minutes” out of the remaining “46 minute” playing period of the data of contents are allocated to the 3D playing period in total. Then, Step S902 described with reference to FIG. 10 is executed.

It should be noted that the special play mode is not limited to the 16-times-speed of the fast-forward playing mode described above. For the special play mode, a playing mode may be selected from a group consisting of various playing modes such as a 1.5-times-speed of playing mode, a triple-speed of playing mode, a 16-times-speed of playing mode and a 32-times-speed of playing mode.

It should be noted that the special play mode is not limited to the fast-forward playing mode. As the special play mode, a rewind playing mode may be executed.

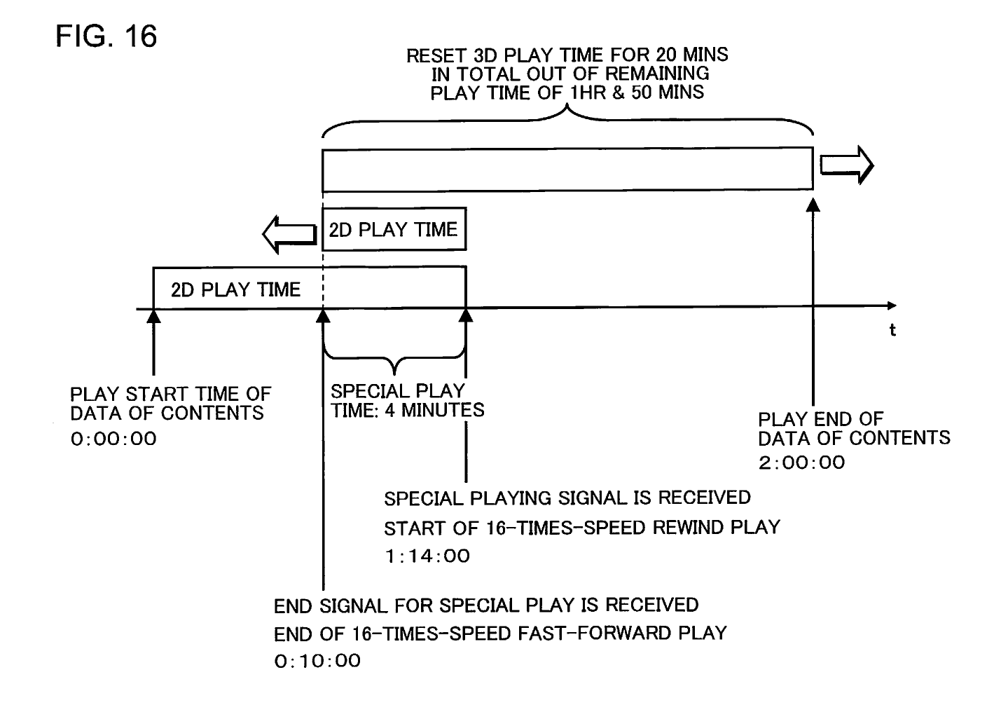

FIG. 16 is a schematic view showing an operation to acquire time information during execution of rewind playing mode.

As shown in FIG. 16, at the time of “1:14:00” in the data of contents, the transceiver 105 receives the special playing signal, which instructs execution of the 16-times-speed of the rewind playing mode. The video player 1 has played the 2D video in response to the 2D video signal for “1 hour and 14 minutes” from the play start time. In addition, the special play mode is performed for “4 minutes”, and normal playing mode is resumed at the time of “0:10:00” in the data of contents. At this time, the controller 106 acquires time information showing that the remaining playing period of the data of contents is “1 hour and 50 minutes”. The controller 106 also acquires time information showing that the operational time information is “20 minutes”.

The controller 106 sets the 3D playing period such that “20 minutes” out of the remaining “1 hour and 50 minutes” of the playing period in the data of contents are allocated to the 3D playing period in total. Then, Step S902 described with reference to FIG. 10 is executed.

It should be noted that if the eyeglass device 3 receives the end signal, which indicates the end of the special play mode, the eyeglass device 3 transmits the remaining charge information to the video player 1. Therefore, in Step S1306, the video player 1 may acquire the remaining charge information of the eyeglass device 3. If the video player 1 acquires the remaining charge information in Step S1306, the operational time information acquired in Step S1307 may be calculated on the basis of the remaining charge information.

In the aforementioned case, even if the user performs pausing as the special play mode, the video player 1 may appropriately set the 3D and 2D playing periods.

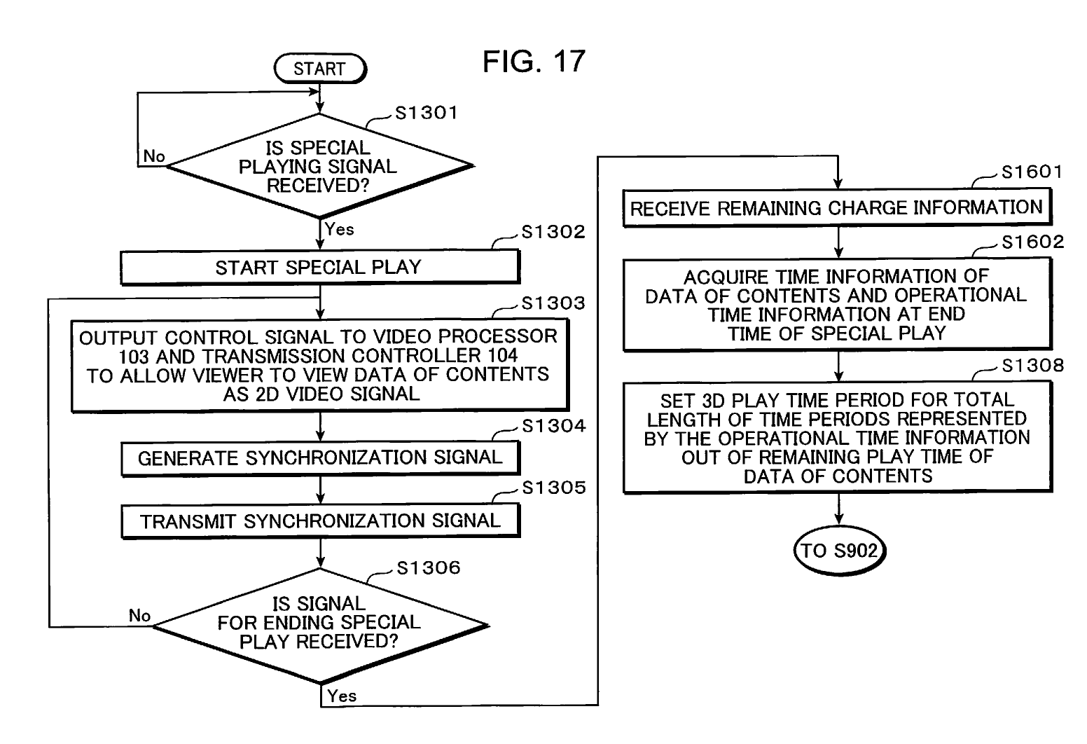

FIG. 17 is a schematic flow chart showing an operation of the video player 1 after the reception of the end signal. The video player 1 acquires the remaining charge information after the reception of the end signal, and sets the operational time information on the basis of the remaining charge information.

### (Step S1601)

After Step S1306, the transceiver 105 receives the remaining charge information transmitted from the eyeglass device 3. The transceiver 105 outputs the received remaining charge information to the controller 106. Then, Step S1602 is executed.

### (Step S1602)

The controller 106 acquires information about the remaining playing period of the data of contents once the end signal is received. The controller 106 calculates the operational time information of the eyeglass device 3 on the basis of the remaining charge information, which has been output from the transceiver 105. Then, Step S1308 is executed.

### Embodiment 4

The video player 1 described in the context of Embodiments 1 to 3 described above switches between the 3D mode in which the 3D video is displayed and the 2D mode in which the 2D video is displayed, on the basis of the remaining charge information transmitted from the eyeglass device 3 to reduce consumption of the battery 304 of the eyeglass device 3. The video player 1 described in the context of Embodiment 4 achieves less frequent communication between the transceivers 105, 301 of the video player 1 and the eyeglass device 3, on the basis of the remaining charge information transmitted from the eyeglass device 3.

In the present embodiment, the same steps as Embodiments 1 to 3 described above are applied to the steps until the comparison by the controller 106 of the video player 1 between the operational time information “t1” and the playing period information “t2” of the data of contents. If the operational time information “t1” is longer than the playing period information “t2” of the data of contents, for example, the transceiver 105 of the video player 1 successively transmits the pulse signal “2” for the notification of the display start of the left frame image, the pulse signal “3” for the notification of the display end of the left frame image, the pulse signal “4” for the notification of the display start of the right frame image, and the pulse signal “5” for the notification of the display end of the right frame image, as shown in the section (b) of FIG. 9.

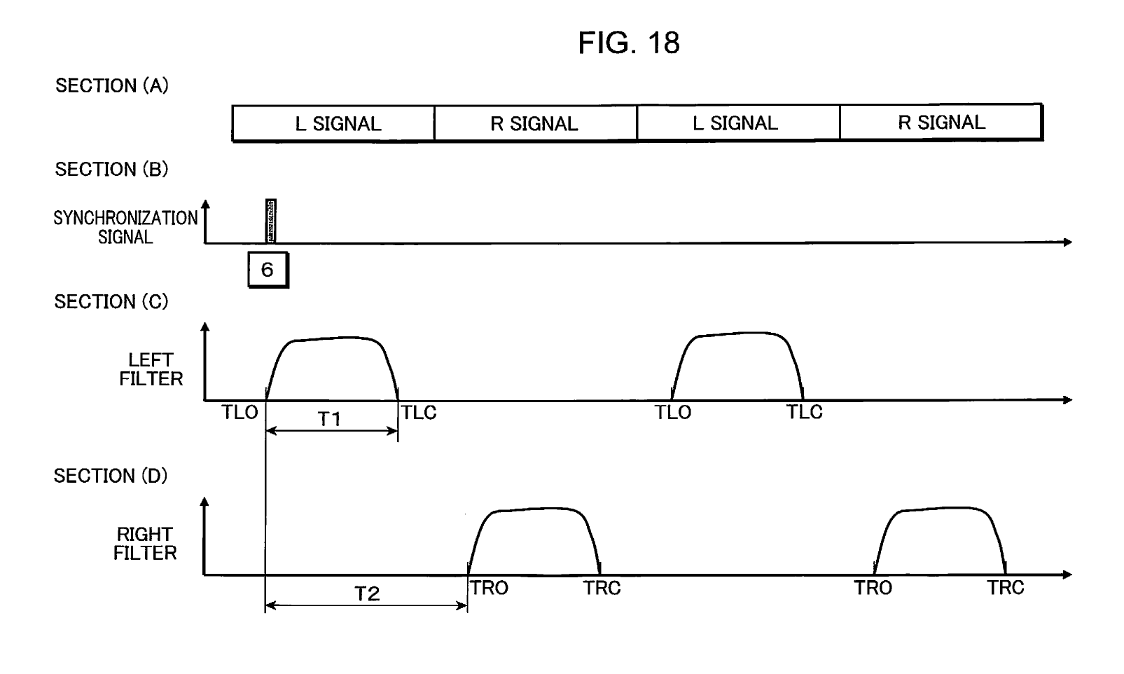

FIG. 18 is a schematic timing chart showing the synchronization signal transmitted by the transceiver 105 of the video player 1 and the operation of the optical filter portion 303 in response to the synchronization signal under a condition of the operational time information “t1” shorter than the playing period information “t2” of the data of contents.

As shown in the section (a) of FIG. 18, the L and R signals are alternately output to the video processor 103. As a result, the display device 2 alternately displays the left and right frame images.

If the operational time information “t1” is shorter than the playing period information “t2” of the data of contents, the controller 106 controls the transmission controller 104 such that the transmission controller 104 generates a pulse signal “6”. For example, the pulse signal “6” notifies the eyeglass device 3 of not only the display start time “TLO” of the left frame image but also a time period “T1” from the display start of the left frame image to the display end of the left frame image and a time period “T2” from the display start of the left frame image to the display start of the right frame image.

If the transceiver 301 of the eyeglass device 3 receives the pulse signal “6”, the controller 302 calculates a time “TLC”, at which the left filter 3031 is closed, on the basis of the display start time “TLO” of the left frame image and the time period “T1” from the display start of the left frame image to the display end of the left frame image. In addition, the controller 302 calculates a time “TRO”, at which the right filter 3032 is opened, on the basis of the time “TLO” of the display start of the left frame image and the time period “T2” from the display start of the left frame image to the display start of the right frame image. The controller 302 adds the time period “T1” to the time “TRO” to calculate a time “TRC”, at which the right filter 3032 is closed. The controller 302 adds a value obtained by multiplying the time period “T2” by an integer to the time “TRO” and calculates the time “TLO” at which the subsequent left frame image is started to display.

As described above, the pulse signal “6” includes information about the time periods “T1” and “T2”. Therefore, the controller 302 of the eyeglass device 3 may successively calculate the times for opening/closing the left and right filters 3031, 3032, which results in less frequent communication between the transceivers 105, 301 of the video player 1 and the eyeglass device 3. The less frequent communication means less consumption of the battery 304.

The arithmetic operation executed by the controller 302 of the eyeglass device 3 is appropriately changed in accordance with the information included in the pulse signal transmitted as the synchronization signal by the transceiver 105 of the video player 1. The pulse signal “6” including the information about the time periods “T1” and “T2” is exemplified in the present embodiment. Alternatively, a pulse signal including other information which makes communication between the transceivers 105, 301 of the video player 1 and the eyeglass device 3 less frequent may be transmitted from the transceiver 105.

The transceiver 105 of the video player 1 may transmit the pulse signal “6” at a reduced cycle period. As a result, it becomes less likely that a gap between the operating cycle period of the eyeglass device 3 and the display cycle period of the frame images displayed on the display device 2 increases.

### Other Embodiments

It should be noted that the controller 106 may cause the display device 2 to display a warning about the remaining battery charge of the eyeglass device 3 if the controller 106 of the video player 1 compares the playing period of the data of contents with the operational time information of the eyeglass device 3 and determines that the operational time information is shorter.

The aforementioned embodiments mainly include the following configurations.

A video system according to the aforementioned embodiments includes: a video player configured to play data of contents to make a video stereoscopically perceived; an eyeglass device used to view the video, wherein the eyeglass device includes: an optical filter portion configured to adjust a light amount reaching eyes of a viewer so that the viewer stereoscopically perceives the video; a battery used as a power supply of the eyeglass device; and a first transceiver configured to transmit information associated with battery charge remaining in the battery to the video player and to receive a synchronization signal for controlling the optical filter portion, and the video player includes: a second transceiver configured to receive the information about the remaining battery charge and to transmit the synchronization signal; and a controller configured to selectively switch an operation mode of the video player based on a comparison result between a playing period of the data of contents and operational time information representing a remaining time period during which the eyeglass device are operable, the operational time information obtained from the received information about the remaining battery.

According to the aforementioned configuration, the video player plays the data of contents to make a video stereoscopically perceived. The viewer uses the eyeglass device to view the video. The optical filter portion of the eyeglass device adjusts the light amount, which reaches the eyes of the viewer, so that the viewer stereoscopically perceives the video. The battery is used as a power supply of the eyeglass device. The first transceiver transmits the remaining charge information about the battery charge, which remains in the battery, to the video player. Meanwhile the first transceiver receives the synchronization signal to control the optical filter portion. The second transceiver of the video player receives the remaining charge information. Meanwhile the second transceiver transmits the synchronization signal. The controller calculates the operational time information of the eyeglass device on the basis of the remaining charge information. If the playing period of the data of contents is longer than the operational time information of the eyeglass device, the controller causes the second transceiver to transmit the synchronization signal so as to reduce consumption of the battery. Therefore it becomes less likely that the eyeglass device runs out of the battery.

In the aforementioned configuration, if the playing period is longer than the remaining time period represented by the operational time information, the controller switches the operation mode of the video player so that the second transceiver transmits the synchronization signal to make the optical filter portion less frequently operated than the optical filter portion operated under a condition in which the playing period is no longer than the remaining time period.

According to the aforementioned configuration, if the playing period of the data of contents is longer than the operational time information of the eyeglass device, the controller causes the second transceiver to transmit the synchronization signal so as to make the optical filter portion less frequently operated. Since the optical filter portion is less frequently operated, battery consumption by the eyeglass device goes down.

In the aforementioned configuration, it is preferable that if the playing period of the data of contents is longer than the remaining time period represented by the operational time information, the controller switches the operation mode of the video player to make communication between the first and second transceivers less frequent.

According to the aforementioned configuration, if the playing period of the data of contents is longer than the operational time information of the eyeglass device, the controller makes communication between the first and second transceivers less frequent. Accordingly, battery consumption by the eyeglass device goes down.

In the aforementioned configuration, it is preferable that the video includes a left frame image to be viewed by a left eye and a right frame image to be viewed by a right eye, the video player further includes: a video processor configured to output a left video signal corresponding to the left frame image and a right video signal corresponding to the right frame image, and if the playing period is longer than the remaining time period represented by the operational time information, the controller switches the operation mode of the video player so that the video processor outputs one of the left and right video signals.

According to the aforementioned configuration, one of the left and right video signals is output, so that the viewer suitably views a two-dimensional video.

In the aforementioned configuration, it is preferable that the optical filter portion keeps an increased light amount reaching the eyes in response to the synchronization signal, which is transmitted while the playing period of the data of contents is longer than the remaining time period represented by the operational time information.

According to the aforementioned configuration, the optical filter portion keeps an increased light amount, which reaches the eyes of the viewer, so that the optical filter portion is less frequently operated. The less frequent operation of the optical filter portion results in less battery consumption by the eyeglass device. Meanwhile, the viewer suitably views the two-dimensional video.

In the aforementioned configuration, it is preferable that the optical filter portion adjusts the light amount in synchronism with one of the left and right frame images in response to the synchronization signal, which is transmitted while the playing period of the data of contents is longer than the remaining time period represented by the operational time information.

According to the aforementioned configuration, the optical filter portion adjusts the light amount, which reaches the eyes of the viewer, in synchronization with one of the left and right video signals. Therefore the optical filter portion is operated less frequently, which results in less battery consumption by the eyeglass device. Meanwhile, the viewer suitably views the two-dimensional video.

In the aforementioned configuration, it is preferable that if the playing period is longer than the remaining time period represented by the operational time information, the controller switches the operation mode of the video player so that the second transceiver transmits the synchronization signals in a 2D playing period during which the light amount is adjusted for the viewer to two-dimensionally perceive the video and in a 3D playing period during which the light amount is adjusted for the viewer to three-dimensionally perceive the video, and the optical filter portion becomes less frequently operated in the 2D playing period than the 3D playing period.

According to the aforementioned configuration, the optical filter is operated less frequently during the 2D playing period, which results in less battery consumption by the eyeglass device.

In the aforementioned configuration, it is preferable that the 3D playing period is set as a time period from a playing end time of the data of contents back to a time by the remaining time period represented by the operational time information, and the 2D playing period is set as a time period shorter by the 3D playing period than the playing period of the data of contents.

According to the aforementioned configuration, the viewer may stereoscopically perceive the video during a time period from the playing end time of the data of contents back to a time by the remaining time period represented by the operational time information. Therefore the viewer may stereoscopically perceive the video of latter parts of the data of contents, which is likely to contain climax scenes.

In the aforementioned configuration, it is preferable that the 3D playing period is set as a time period from a playing start time of the data of contents forward to a time by the remaining time period represented by the operational time information, and the 2D playing period is set as a time period shorter by the 3D playing period than the playing period of the data of contents.

According to the aforementioned configuration, the viewer may stereoscopically perceive the video during a time period from the playing start time of the data of contents forward to a time by the remaining time period represented by the operational time information. Thereafter, the viewer may two-dimensionally perceive the video. While latter parts of the data of contents are played, it is likely that the viewer feels eye fatigue because of the previous stereoscopic viewing. Since the viewer is less likely to stereoscopically perceive the video while latter parts of the data of contents are played, the eye fatigue of the viewer is moderated.

In the aforementioned configuration, it is preferable that the data of contents includes audio data, and the controller sets a time period as the 3D playing period if the audio data has a sound volume which is no less than a predetermined level.

According to the aforementioned configuration, while the audio data has a sound volume, which is no less than the predetermined level, the viewer may stereoscopically perceive the video. Therefore, the viewer may stereoscopically perceive relatively exciting scenes of the video.

In the aforementioned configuration, it is preferable that the data of contents includes data about at least one start time and at least one end time of the 3D playing period, and the controller transmits the synchronization signal to adjust the light amount so as to allow the viewer to three-dimensionally perceive the video based on the data about the start and end times of the 3D playing period.

According to the aforementioned configuration, the viewer may stereoscopically perceive the video in a specific portion of the data of contents.

In the aforementioned configuration, it is preferable that if a time period from the start time to the end time of the 3D playing period is longer than the remaining time period represented by the operational time information, a time period from the closest start time of the 3D playing period to a leading end of the data of contents forward to a time by the remaining time period represented by the operational time information is set as the 3D playing period by the controller.

According to the aforementioned configuration, the viewer may stereoscopically perceive the video during a period from the closest start time of the 3D playing period to a leading end of the data of contents forward to a time by the remaining time period represented by the operational time information.

In the aforementioned configuration, it is preferable that if a time period from the start time to the end time of the 3D playing period is longer than the remaining time period represented by the operational time information, a time period from the closest end time of the 3D playing period to a terminal end of the data of contents back to a time by the remaining time period represented by the operational time information is set as the 3D playing period by the controller.

According to the aforementioned configuration, the viewer may stereoscopically perceive the video during a time period from the closest end time of the 3D playing period to a terminal end of the data of contents back to a time by the remaining time period represented by the operational time information.

In the aforementioned configuration, it is preferable that the data of contents includes data about the start times and the end times of the 3D playing periods and priorities in preferential setting of the 3D playing periods, and if a total time period from the start times to the end times of the 3D playing periods is longer than the remaining time period represented by the operational time information, a time period from the start time to the end time is sequentially set in order of the preferential setting as the 3D playing period based on the data about the priorities.

According to the aforementioned configuration, the viewer may preferentially stereoscopically perceive the video, which is set as high priority.

In the aforementioned configuration, it is preferable that the video player further includes: a playing portion configured to play the data of contents, if the second transceiver receives a change signal for changing a playing operation by the playing portion for a predetermined time period, the controller makes the playing portion change the playing operation for the predetermined time period, if the second transceiver newly receives the information about the remaining battery charge after the predetermined time period passes, the controller newly calculates the remaining time period represented by the operational time information based on the newly received information about the remaining battery charge, and if a remaining playing period of the data of contents is longer than the remaining time period represented by the newly calculated operational time information, the controller sets the 2D playing period and the 3D playing period.

According to the aforementioned configuration, even if there is a change in the playing operation by the playing portion, the controller appropriately sets the 2D playing period and the 3D playing period, which results in less battery consumption by the eyeglass device.

In the aforementioned configuration, it is preferable that if the playing period of the data of contents is longer than the remaining time period represented by the operational time information, the controller outputs a warning about the remaining battery charge.

According to the aforementioned configuration, it becomes likely that the viewer replaces the batteries. Therefore it becomes less likely that the eyeglass device runs out of the battery.

An eyeglass device used to view a video according to another aspect of the aforementioned embodiments includes: an optical filter portion configured to adjust a light amount reaching eyes of a viewer so that the viewer stereoscopically perceives the video; a battery used as a power supply of the eyeglass device; and a first transceiver configured to transmit remaining charge information about battery charge remaining in the battery to a video player and to receive a synchronization signal for controlling the optical filter portion.

According to the aforementioned configuration, the eyeglass device transmits the remaining charge information about the battery charge, which remains in the battery. Thus, the remaining charge information about the remaining battery charge of the eyeglass device may be appropriately transmitted.

A video player for playing data of contents, which makes a video stereoscopically perceived by means of an eyeglass device according to yet another aspect of the aforementioned configurations includes: a second transceiver configured to receive information about charge remaining in a battery used as a power supply of the eyeglass device and to transmit a synchronization signal for controlling the eyeglass device; and a controller configured to calculate a remaining time period, during which the eyeglass device are operable, represented by operational time information obtained from the received information about the charge remaining in the battery, the controller makes the second transceiver transmit the synchronization signal to decrease consumption of the battery if a playing period of the data of contents is longer than the remaining time period represented by the operational time information.

According to the aforementioned configuration, the viewer may stereoscopically perceive the data of contents, which is played by the video player, by means of the eyeglass device. The second transceiver of the video player receives the remaining charge information and transmits the synchronization signal. The controller calculates the remaining time period represented by the operational time information of the eyeglass device on the basis of the remaining charge information. If the playing period of the data of contents is longer than the remaining time period represented by the operational time information, the second transceiver transmits the synchronization signal so as to reduce the battery consumption. Therefore, it becomes less likely that the eyeglass device runs out of the battery.

### INDUSTRIAL APPLICABILITY

The principles according to a series of the aforementioned embodiments are suitably applicable to systems or devices for allowing a viewer to view a stereoscopic video by means of an eyeglass device.

1. A video system, comprising:
a video player configured to play data of contents to make a video stereoscopically perceived;
an eyeglass device used to view the video, wherein the eyeglass device includes:
an optical filter portion configured to adjust a light amount reaching eyes of a viewer so that the viewer stereoscopically perceives the video;
a battery used as a power supply of the eyeglass device; and
a first transceiver configured to transmit information associated with battery charge remaining in the battery to the video player and to receive a synchronization signal for controlling the optical filter portion, and
the video player includes:
a second transceiver configured to receive the information about the remaining battery charge and to transmit the synchronization signal; and
a controller configured to selectively switch an operation mode of the video player based on a comparison result between a playing period of the data of contents and operational time information representing a remaining time period during which the eyeglass device are operable, the operational time information obtained from the received information about the remaining battery.

2. The video system according to claim 1, wherein
if the playing period is longer than the remaining time period represented by the operational time information, the controller switches the operation mode of the video player so that the second transceiver transmits the synchronization signal to make the optical filter portion less frequently operated than the optical filter portion operated under a condition in which the playing period is no longer than the remaining time period.

3. The video system according to claim 1, wherein
if the playing period of the data of contents is longer than the remaining time period represented by the operational time information, the controller switches the operation mode of the video player to make communication between the first and second transceivers less frequent.

4. The video system according to claim 1, wherein
the video includes a left frame image to be viewed by a left eye and a right frame image to be viewed by a right eye,
the video player further includes:
a video processor configured to output a left video signal corresponding to the left frame image and a right video signal corresponding to the right frame image, and,
if the playing period is longer than the remaining time period represented by the operational time information, the controller switches the operation mode of the video player so that the video processor outputs one of the left and right video signals.

5. The video system according to claim 4, wherein
the optical filter portion keeps an increased light amount reaching the eyes in response to the synchronization signal, which is transmitted while the playing period of the data of contents is longer than the remaining time period represented by the operational time information.

6. The video system according to claim 4, wherein
the optical filter portion adjusts the light amount in synchronism with one of the left and right frame images in response to the synchronization signal, which is transmitted while the playing period of the data of contents is longer than the remaining time period represented by the operational time information.

7. The video system according to claim 2, wherein
if the playing period is longer than the remaining time period represented by the operational time information, the controller switches the operation mode of the video player so that the second transceiver transmits the synchronization signals in a 2D playing period during which the light amount is adjusted for the viewer to two-dimensionally perceive the video and in a 3D playing period during which the light amount is adjusted for the viewer to three-dimensionally perceive the video, and
the optical filter portion becomes less frequently operated in the 2D playing period than the 3D playing period.

8. The video system according to claim 7, wherein
the 3D playing period is set as a time period from a playing end time of the data of contents back to a time by the remaining time period represented by the operational time information, and
the 2D playing period is set as a time period shorter by the 3D playing period than the playing period of the data of contents.

9. The video system according to claim 7, wherein
the 3D playing period is set as a time period from a playing start time of the data of contents forward to a time by the remaining time period represented by the operational time information, and
the 2D playing period is set as a time period shorter by the 3D playing period than the playing period of the data of contents.

10. The video system according to claim 7, wherein
the data of contents includes audio data, and
the controller sets a time period as the 3D playing period if the audio data has a sound volume which is no less than a predetermined level.

11. The video system according to claim 7, wherein
the data of contents includes data about at least one start time and at least one end time of the 3D playing period, and
the controller transmits the synchronization signal to adjust the light amount so as to allow the viewer to three-dimensionally perceive the video based on the data about the start and end times of the 3D playing period.

12. The video system according to claim 11, wherein
if a time period from the start time to the end time of the 3D playing period is longer than the remaining time period represented by the operational time information, a time period from the closest start time of the 3D playing period to a leading end of the data of contents forward to a time by the remaining time period represented by the operational time information is set as the 3D playing period by the controller.

13. The video system according to claim 11, wherein
if a time period from the start time to the end time of the 3D playing period is longer than the remaining time period represented by the operational time information, a time period from the closest end time of the 3D playing period to a terminal end of the data of contents back to a time by the remaining time period represented by the operational time information is set as the 3D playing period by the controller.

14. The video system according to claim 11, wherein
the data of contents includes data about the start times and the end times of the 3D playing periods and priorities in preferential setting of the 3D playing periods, and
if a total time period from the start times to the end times of the 3D playing periods is longer than the remaining time period represented by the operational time information, a time period from the start time to the end time is sequentially set in order of the preferential setting as the 3D playing period based on the data about the priorities.

15. The video system according to claim 6, wherein
the video player further includes a playing portion configured to play the data of contents,
if the second transceiver receives a change signal for changing a playing operation by the playing portion for a predetermined time period, the controller makes the playing portion change the playing operation for the predetermined time period,
if the second transceiver newly receives the information about the remaining battery charge after the predetermined time period passes, the controller newly calculates the remaining time period represented by the operational time information based on the newly received information about the remaining battery charge, and
if a remaining playing period of the data of contents is longer than the remaining time period represented by the newly calculated operational time information, the controller sets the 2D playing period and the 3D playing period.

16. The video system according to claim 1, wherein
if the playing period of the data of contents is longer than the remaining time period represented by the operational time information, the controller outputs a warning about the remaining battery charge.

17. An eyeglass device used to view a video, comprising:
an optical filter portion configured to adjust a light amount reaching eyes of a viewer so that the viewer stereoscopically perceives the video;
a battery used as a power supply of the eyeglass device; and
a first transceiver configured to transmit remaining charge information about battery charge remaining in the battery to a video player and to receive a synchronization signal for controlling the optical filter portion.

18. A video player for playing data of contents, which makes a video stereoscopically perceived by means of an eyeglass device, comprising:
a second transceiver configured to receive information about charge remaining in a battery used as a power supply of the eyeglass device and to transmit a synchronization signal for controlling the eyeglass device; and
a controller configured to calculate a remaining time period, during which the eyeglass device are operable, represented by operational time information obtained from the received information about the charge remaining in the battery,
the controller makes the second transceiver transmit the synchronization signal to decrease consumption of the battery if a playing period of the data of contents is longer than the remaining time period represented by the operational time information.
